(19) United States
(12) Patent Application Publication
(10) Pub. No.: US 2010/0201121 A1
(43) Pub. Date: Aug. 12, 2010

(54) H.V.A.C variable size saddle tap fitting

(76) Inventor: Gary Andrew Jensen, Napa, CA (US)

Correspondence Address: GARY ANDREW JENSEN, 268 COUNTRY CLUB LANE, NAPA, CA, 94558, US

(21) Appl. No.: 12/658,218

(22) Filed: Feb. 4, 2010

Related U.S. Application Data
(60) Provisional application No. 61/207,165, filed on Feb. 9, 2009.

(51) Int. Cl. F16L 41/08

(52) U.S. Cl. 285/189

(57) ABSTRACT

The purpose is to extract conditioned air through the use of a saddle tap fitting made of sheet metal or other material for attaching a rectangular or square discharge to registers or duct to a round or the round sides of an oval HVAC main trunk line or short sections of pipe of many different sizes as well as tapers, reducers or fittings. With the use of this fitting will reduce huge amounts of manufacturing and inventory. This saddle tap which flexibly conforms tightly to the arcuate surface to which it is attached will deliver less turbulent conditioned air to desired locations. A key feature of the fitting is several attachment tabs typical of (30) with restraining holes (31) in them. Together tabs and restraining holes, keep the attachment screws from drifting when the screws are installed through said holes and angled away from the large hole cut in the main line to secure the tap to the main trunk line. This procedure allows the screws to stress the saddle tap fitting to conform tightly to the main line.

This Application Claims The Benefit Of Priority Of Provisional Patent Application 61/207,165 Was Filed Feb. 9, 2009 and Entitled H.V.A.C. Variable Size Saddle Tap Fitting

### BACKGROUND OF THE INVENTION

1. Field of Invention

1—This sheet metal fitting relates to the heating ventilating and air conditioning H.V.A.C. systems and particular for tapping square or rectangular taps into main trunk lines that are round or the round sides of oval pipe of many different sizes of trunk lines.

2. Description of the Related Art

Air flows thru round pipe easier than rectangular duct of comparable size which saves energy and labor. Round or oval duct can be made in 20′ plus lengths, where as. Rectangular duct can generally be made and installed only 4′ or 5′ lengths, which require many more expensive joints because of a lot more labor and material for joints and duct sealer as well, and rectangular duct is weaker than round it needs more support. Round duct and its fittings are readily availably at H.V.A.C. supply houses, and specific rectangular duct has to be ordered from manufacturing shops which takes much more time. Also there are no corners on round pipe so it can be tapped all the way around the circumference of the pipe with a arcuate tap which makes it much more versatile to work with especially in tight space situations. So the round or oval pipe is generally preferred. The problem with rectangular taps into round is the arcuate part of the tap only will fit a specific size it was made for which requires making storing and shipping huge quantities of specific size fittings.

In the H.V.A.C. industry registers can be cut into the main trunk lines without taps but then when the register is installed and it's accompanying volume damper it would be recessed into the main line which will restrict air flow, also the remedy is to have a tap that extends off the main line to contain the register and the volume damper. This requires a tap which needs to be rectangular or square as to fit rectangular or square registers on one end but be able to tap a round or oval main trunk line on the other end. A typical trunk line will enter a building at a certain size then the first register saddle tap is cut into it, then it reduces in size and continues more distance then another register saddle tap is cut in and the main line is reduced again continues on to the next register saddle tap is cut in, This process is continued over and over until the end of the trunk line. So typically at every saddle tap is required to fit a different diameter pipe which requires a huge supply of saddle taps, then if the tap does fit the main line diameter, it might not fit the requested register size length.

EXAMPLE might be an 8″ high by 10″ wide rectangular register to a 16″ round diameter pipe. But as you continue down the reduced trunk line size to EXAMPLE 8″×10″ to a 12″ round diameter main line you need many more specific size fittings which is a huge problem. Involving much more expense due to manufacturing, availability, storage, and bulk shipping costs. These and other problems can be greatly reduced with the use of this invention.

### DESCRIPTION OF PRIOR ART

Paoluccio U.S. Pat. No. 5,080,403—Jan. 14, 1992—285/229 has a bellows fitting.

Is made of multiple materials, fabric and metal and many parts, expensive to make.

Needs interior liner for less turbulent air flow.

Needs brackets to brace or restrain fitting while in use.

Needs to be forced into angles off the main line which would bunch up the bellows fitting causing problems.

Exterior use of this fitting to sunlight would make it rot.

Has many seams to seal.

The use of the fabric bellows gives a foreign appearance with the metals that make up the main trunk line and branch line.

Fabric bellows very weak easily collapsible in or under concrete applications.

To flexible needs hangar to support the discharge end to the branch line.

Wachter U.S. Pat. No. 4,147,382—Apr. 3, 1979—285/189; 285/424

Has a long narrow slot and can not be nested.

The tap into the main line has to be long in order to have enough volume to supply the branch line.

It takes to much space.

Cutting in the long slot would weaken the main line.

The long flat sides of the fitting are weak and could collapse when used in concrete under floor applications.

Narrow slot has to much air turbulence which would use lots of energy to move air.

Current U.S. Class 285/229, 285/424, 285/216, 285/183, 285/286.2, 285/286, 285/298, 285/382, 285/382.4, 285/330, 285/212

Current International Class F16L 55/00

Field of Search 285/229, 189, 183, 123.1, 15, 114, 110, 424

Prior art.

| | |
|---|---|
| U.S. Pat. No. 5,080,403 - Paoluccio, John A - Jan. 14, 1992 | 285/229 |
| U.S. Pat. No. 4,147,382 - Wachter, Eric Apr. 03, 1979 | 285/189 |
| U.S. Pat. No. 5,957,506 - Stepp, Michael D. - Sep. 28, 1999 | 285/183 |
| U.S. Pat. No. 5,328,213 - Barth James T. - Jul. 12, 1994 | 285/123.1 |
| U.S. Pat. No. 5,340,160 - Meijers et al. - Aug. 23, 1994 | 285/15 |
| U.S. Pat. No. 4,627,646 - Kessel Bernhard - Dec. 09, 1986 | 285/114 |
| U.S. Pat. No. 7,523,964 - Langdon Incorporated - Mar. 24, | 285/110 |
| 2005 | |

### OBJECTS OF THE INVENTION

A—In view of foregoing considerations it is an object of the invention to provide a saddle tap fitting which is adaptable to round or the round sides of oval main trunk lines and fittings of many different sizes to a square or rectangular discharge for the purpose of extracting H.V.A.C. conditioned air to a register or grille or duct in one fitting.
B—Another object is to tap the main trunk line with a larger size tap on the main line, than the size to the register for a larger volume of less turbulent air for better air flow, saving energy.
C—Another is to have a tap that appears to be specifically made to fit the pipe it attached to.
D—Another object is to be able to attach to scrap pipe that normally would be thrown away saving resources.
E—Mother object it is very strong and can be buried under concrete, for under floor applications.
F—Another object can be installed in difficult and tight situations.
G—Mother object simple to make, made of one material—METAL 26 gauge galvanized sheet metal preferred but other gauges are acceptable 30 gauge to 10 gauge. Saving expense although it could be made of plastic or other material.
H—In addition it can be nested. Fittings of the same size can be inserted in one another saving space, storage, and shipping charges.
I—Another object has an interior acoustic coating.
J—Another object the preferred embodiment has a register flange around the discharge so the fitting will have strength and backing for the register gasket to seal to.
K—Another object the two piece version can be expanded to different register lengths.
L—Another object the register flanges have numbered inch marks on them to indicate the size of the register that it will fit, when expanded or contracted.
M—Mother object the interior extractor flexibly adapts to the size the main trunk line is attached to.
N—Another object can be lined with insulation or wrapped.
O—Another object can be made of Stainless steel for corrosive situations.
P—Still another object extractor can be lowered to multiple depths in the main line for more or less air as desired.
Q—Another object extractor has a multi position use indicator and securing strap.
R—Another object it will replace a multitude of other fittings.
S—Another object the exterior is easy to clean for housekeeping purposes in exposed situations.
T—Another object is this fitting is a high volume air tap.
U—Another object is that the exterior is aesthetically pleasing.

These and other objects and advantages will become apparent from the specifications and drawings.

### SUMMARY OF THE INVENTION

These and other objects are met by the present invention which in the first aspect provides a saddle tap fitting for attaching an end of a branch line duct section of a relatively small cross section to an arcuate surface of a main line of a moderately larger size than the branch line or to a much larger size main line to a rectangular duct or register or grille and extract conditioned air to a register with the use of one fitting. Saving large amounts of specific size fittings.

This invention contains two versions.

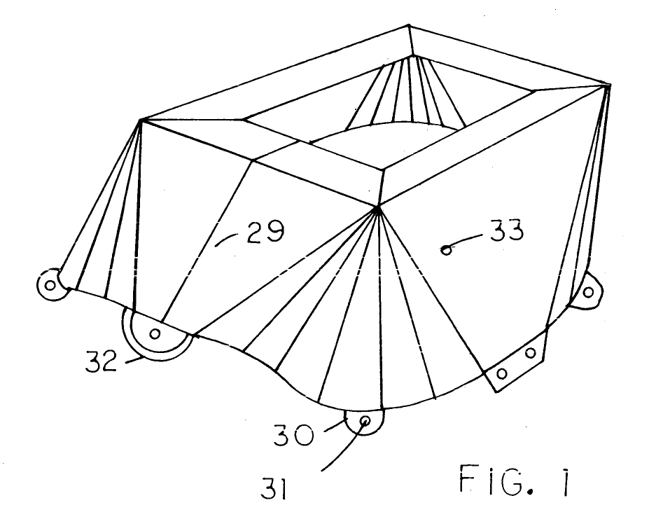

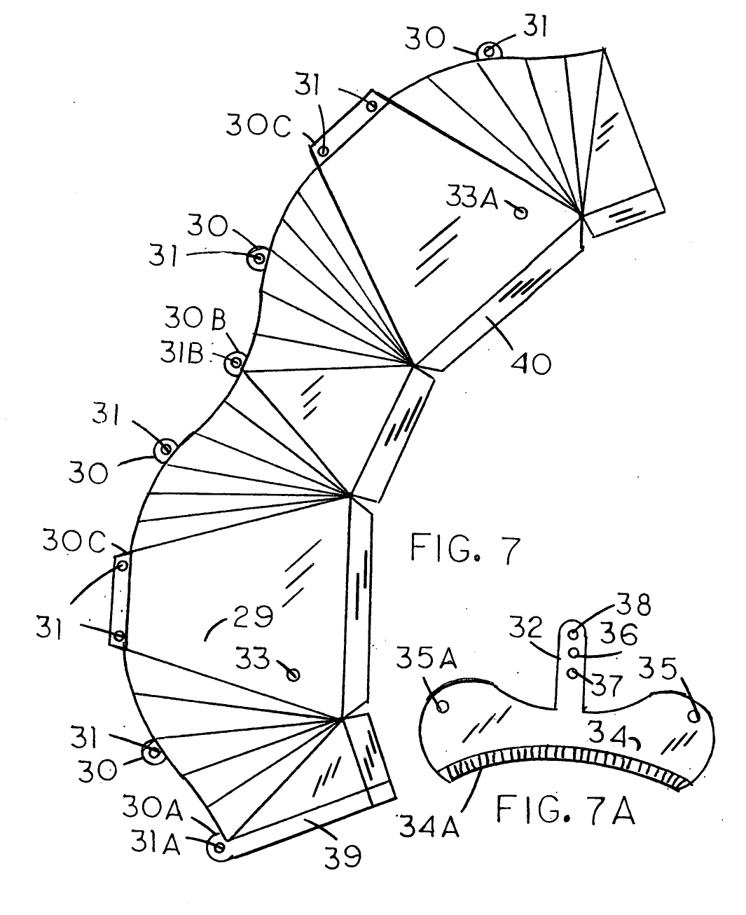

Version #1—is a one piece register and ductwork tap combination pg. 5/12—FIG. 7 and one piece extractor see page 5/12—FIG. 7A. See page 1/12 FIG. 1. This version has a register flange bent in at an angle around the perimeter for the register to secure and seal to and to strengthen the fitting. On the opposite end it has several typical attachment tabs 30 with holes in them 31 around the perimeter that attaches the saddle tap fitting to the main trunk line. When the attachment screws are run thru hole 31 at a angle away from the large air access hole cut in main line. The base of fitting distorts to fit main line curvature. This fitting has an interior air extractor 34 to extract extra air if needed. (Example) So if this version will fit 9 different sizes of round main trunk lines, and the round sides of 9 different sizes of oval pipe.

Version 2—pg. 9/12 FIGS. 11 and 11A is made of two pieces 44 that are tightly inter locked, both pieces are identical to save fabrication time and effort. The only difference is two extractor attachment and pivot holes 33 in one of them. The two saddle tap pieces slip together and form the fitting which is expandable to desired register lengths. The register flange 40 has numbered inch length indicator marks 50 which are used to indicate desired register lengths. Once this length is determined both pieces can be secured together and tapped into the main trunk line. Identical to version 1—version 2 is more versatile because (Example) So not only can it fit 9 different sizes of round pipes and the round side of 9 different oval pipes, it will expand to 6 different length sizes, so when version 1 will fit 9 different round size pipes and 9 different oval sizes equaling 18 Applications.

Version 2 will fit the same 18 different pipe sizes. (Example) It will expand to 6 different lengths, making it capable of 18×6=108 combinations of different applications. Saving the manufacturing and stocking of large amounts specific size fittings saving space time and money. Version 2 also has the same extractor and benefits as version 1, they are identical.

### BRIEF DESCRIPTION OF THE DRAWINGS

Pg. 1/12 FIG. 1—shows saddle tap fitting 29 with attachment tabs 30 with holes 31 typical. The number 32 is the attachment and restraining strap for the extractor 34 not shown.

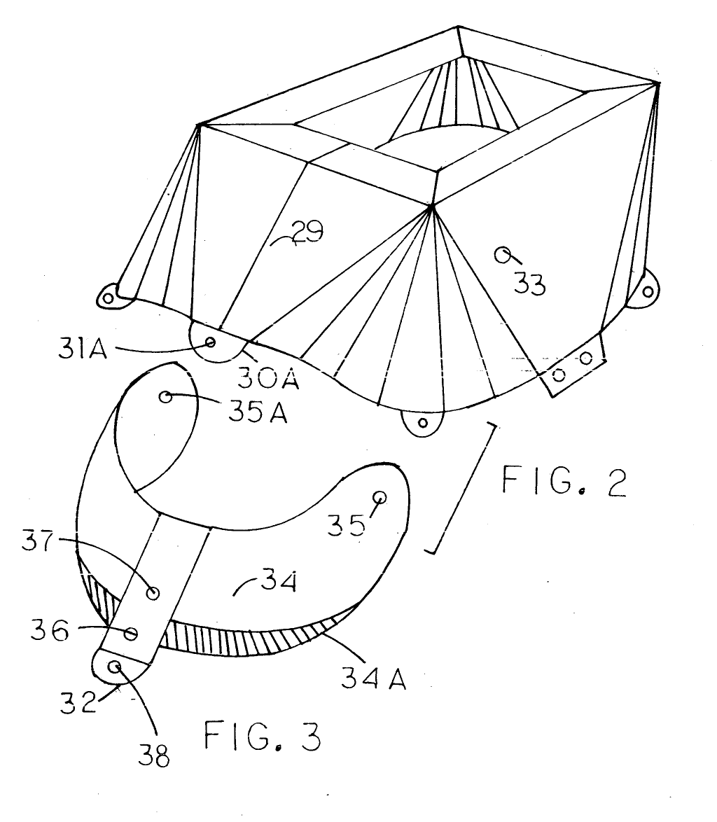

Pg. 2/12 FIG. 2 and FIG. 3 Detached view shows FIG. 2 saddle tap fitting 29 with extractor, securing and pivoting hole 33. Number 34 is the extractor with holes 35 and 35A which attach and work in conjunction with holes 33 and 33A (not shown) on fitting 29. Once the extractor is installed inside fitting 29 and secured thru holes 33 and 35 and 33a and 35a the extractor can pivot up or down. The depth indicator restraining strap 32 has holes 36-37-38 which is used for setting desired and securing a depth of the extractor.

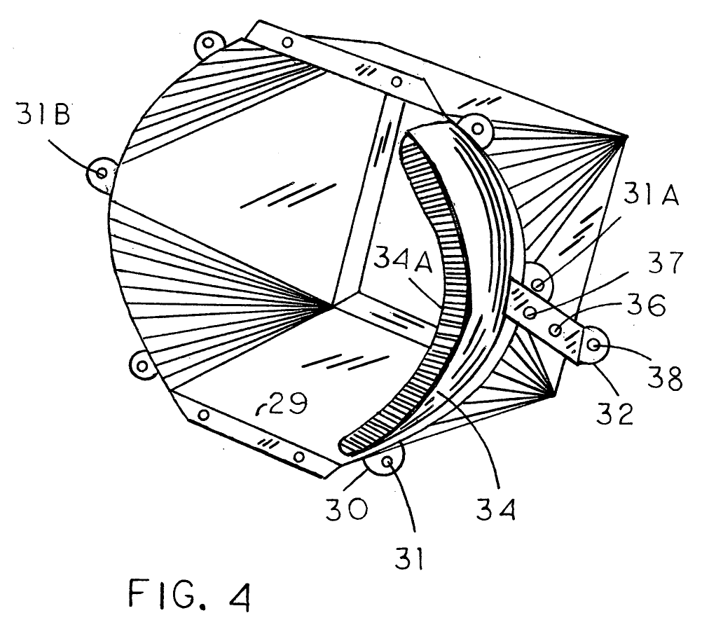

Pg. 3/12 FIG. 4 shows fitting 29 laying on its side to expose extractor 34 and its crimped edge 34A which stiffens, and is the leading edge of extractor. 32 is the extractor strap and its holes 36 37 38 number 30 is an attachment tab 31 is the hole in the attachment tab 31A 31B are holes in attachment tabs.

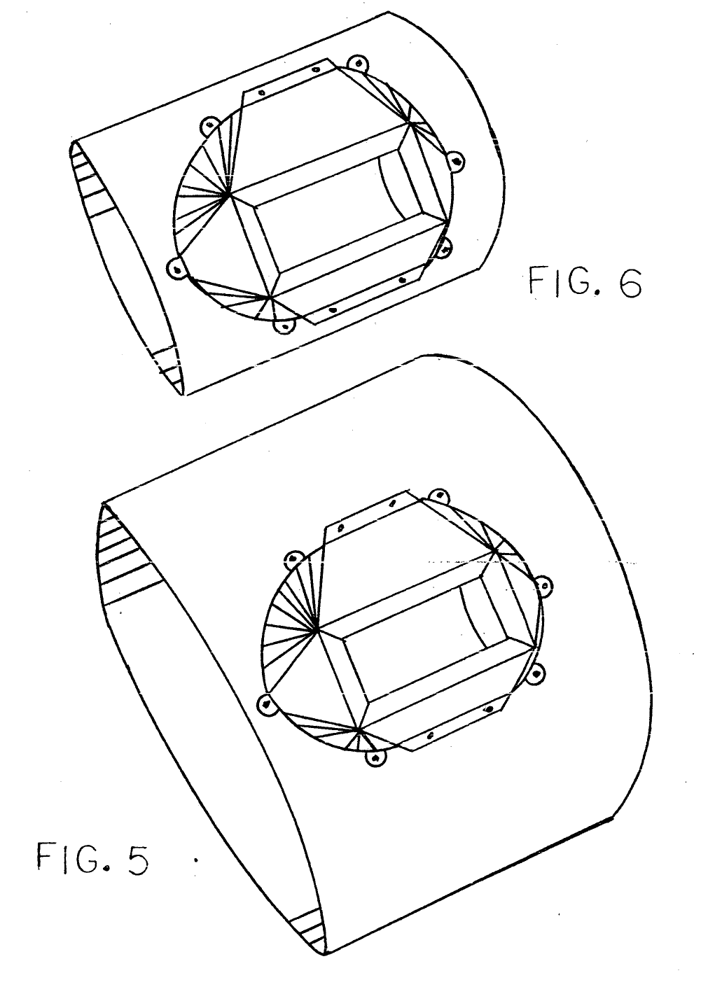

Pg. 4/12—FIG. 5 and FIG. 6 FIG. 5 shows the fitting on a large pipe FIG. 6 shows fitting on a small pipe.

Pg. 5/12 FIG. 7 is the one piece flat pattern shown with its lines to be bent up for Version#1 for fitting 29 number 39 is the lap seam. Number 30 is the most typical attachment tab. Number 31 is the most typical attachment hole. Number 30A is the attachment tab the extractor strap 32 is secured under. Number 31A is the securing hole. Tab 30B and hole 31B is the tab and hole opposite to TAB 30A and hole 31A when the saddle tap fitting is formed up these tab and hole combinations are used for leveling references. Also they are used for securing the extractor and stressing the saddle tap fitting as well as securing it to the main line. Number 30C is a flange that is to be kinked out at a slight angle used to keep the side of the fitting flat. Number 40 to be bent in at an angle for strength and backing for sealing and attaching the register to. FIG. 7A is the flat pattern for the extractor 34 and 34A is to be the crimped leading edge.

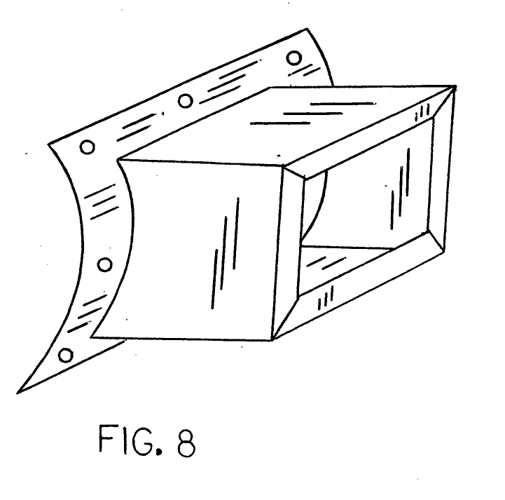

Pg. 6/12 FIG. 8 shows a type of fitting available now which is one size specific fitting which my saddle tap can replace.

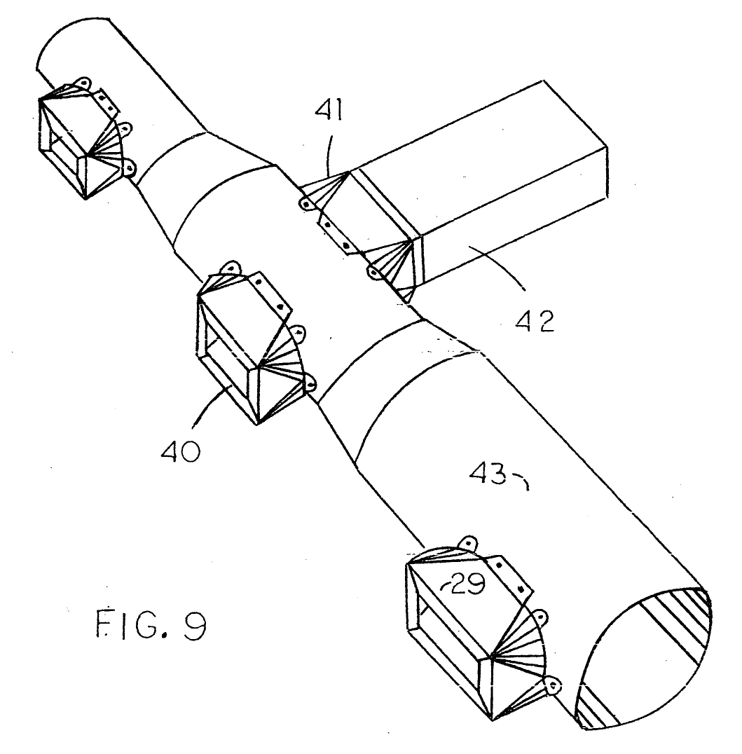

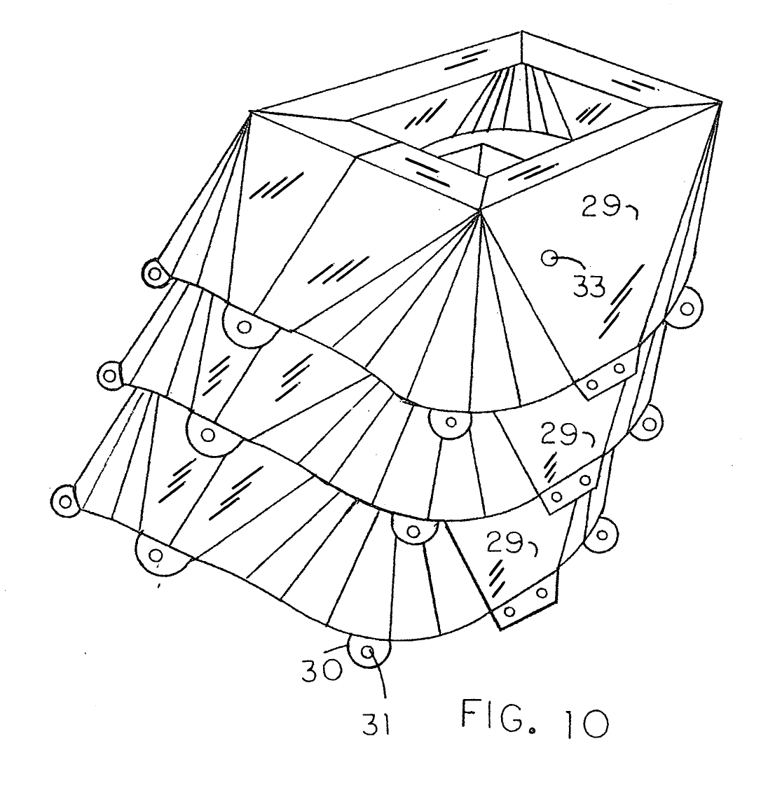

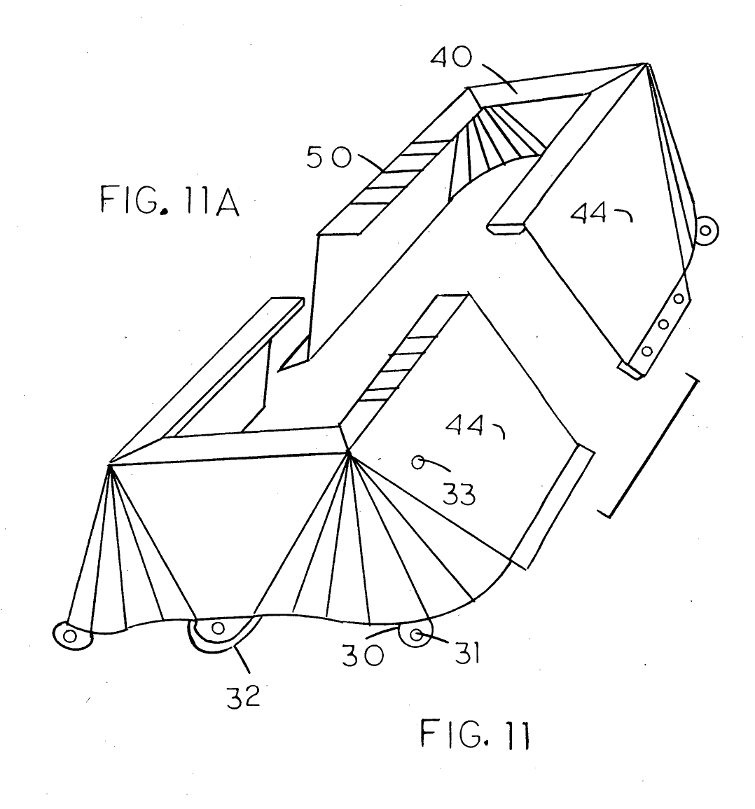

Pg. 7/12 FIG. 9 shows a small portion of a main trunk line with 3 different pipe sizes and 2 reducers. It has 3 identical saddle taps 29 on it for registers. One saddle tap 41 for rectangular or square duct application 42.

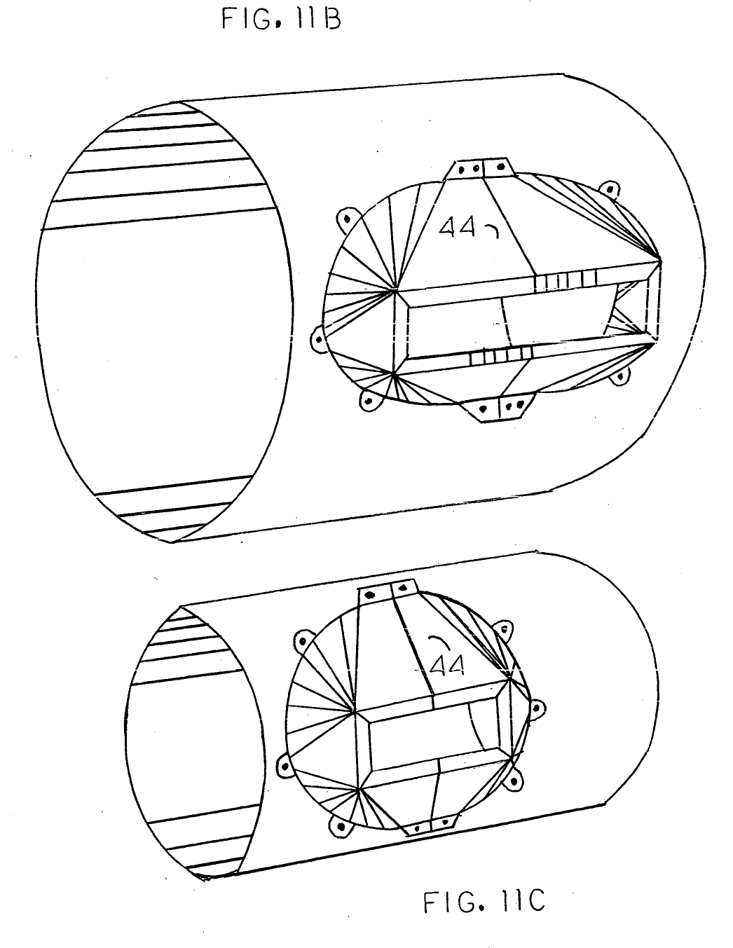

Pg 8/12 FIG. 10 shows 3 saddle tap fittings 29 loosely nested to save space for storage and shipping purposes. Prior to extractor installation.

Pg 9/12 FIG. 11-11-A shows the two pieces 44 of version 2 the expandable register length fitting. Number 50 is the inch length indicator marks on flange 40 that indicate how long or short the fitting needs to be adjusted to fit a specific length size register length. Then when the marks are exposed by expanding the fitting after the two pieces are interlocked this indicates the desired register length. Number 32 is the end of the extractor strap. The extractor is not shown.

Pg 9/12A FIG. 11B show a expandable fitting expanded to its maximum length on a large diameter pipe. FIG. 11C shows the expandable fitting compressed to its minimum length on a small diameter pipe which shows versatility

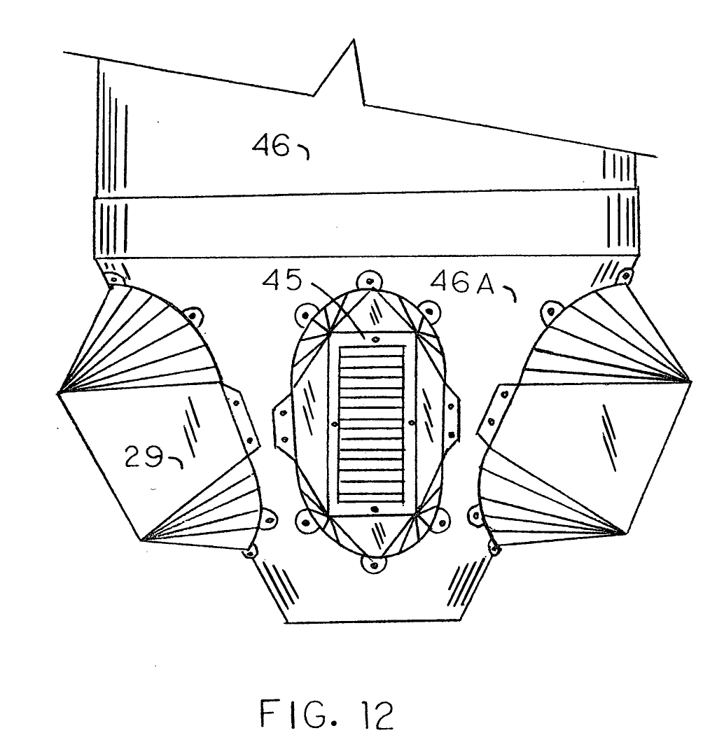

Pg 10/12 FIG. 12 shows 3 fittings 29 mounted on 46A which is a reducer with an end cap. And pipe 46 is extended down thru the roof from H.V.A.C. unit. Taps are mounted on 4 sides with register 45 installed in them, this shows versatility of this fitting.

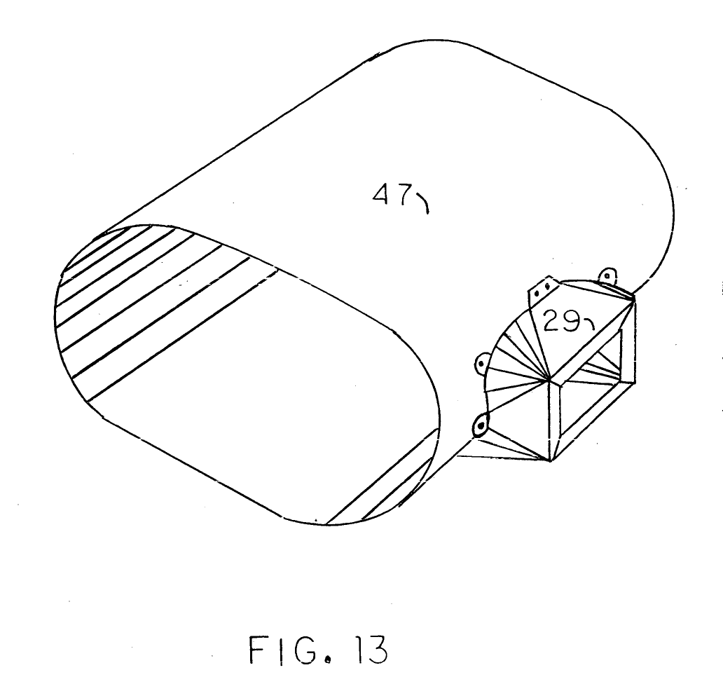

Pg. 11/12—FIG. 13 shows the fitting 29 mounted on large oval main trunk line 47. Which can be many different sizes.

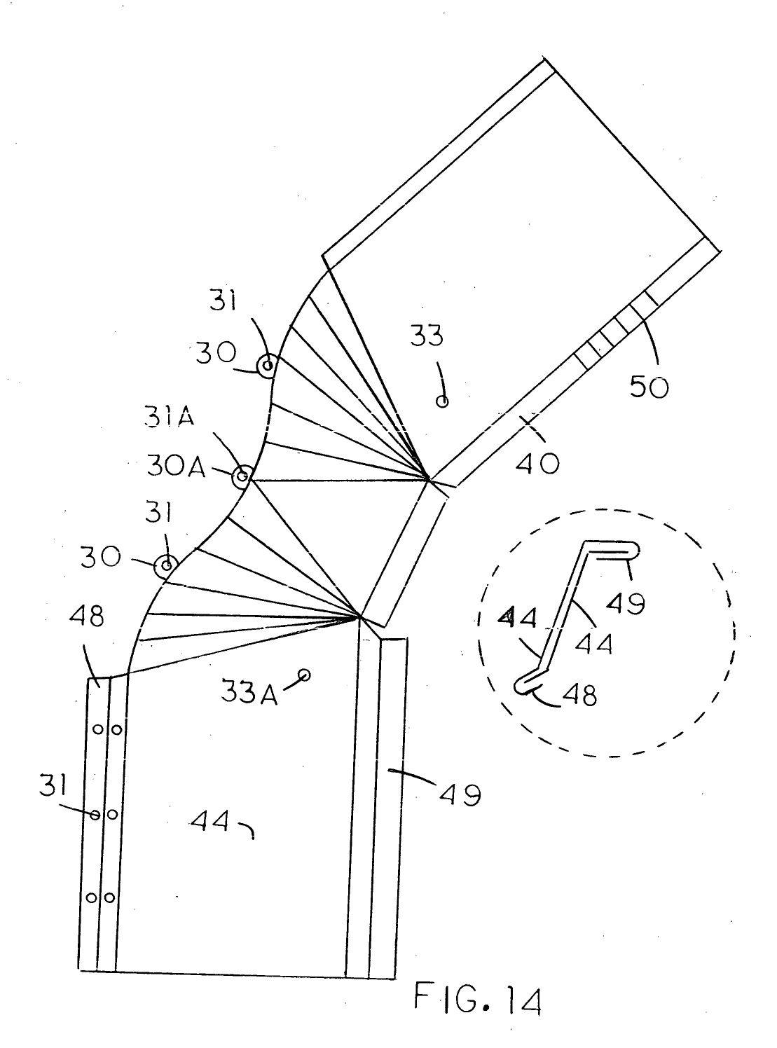

Pg 12/12 FIG. 14 shows flat pattern with lines to be bent up for fitting version 2 44 which is a ½ pattern of the expandable version 2. The detail shows how it is interlocked. Number 48 and 49 are hemmed and 48 is kinked out at a slight angle while 49 is bent in at a greater angle for strength and backing for registers to seal to. This also allows the other half pattern to inter lock to complete the tap this will allow the completed fitting to manually slide in or out. This changes the length enabling it to receive smaller or larger registers. Number 50 is the inch marks used to gauge register lengths. Number 40 is the register flange. Number 30 is a typical attachment tab. Number 31 is a typical attachment hole. Number 30A tab and 31A hole is the tab and hole that the extractor strap 32 is attached under. Number 33 and 33A are the attachment and pivot holes for securing the extractor.

### DESCRIPTION OF PREFERRED EMBODIMENT

While the present invention is open to various modification and alternative constructions the embodiment shown in the drawings will be described here in detail. It is to be understood how ever there is no intention to limit the invention to the particular form disclosed. On the contrary it is intended that the invention cover all modifications, equivalences and alternative constructions falling within the spirit and scope of the invention as expressed in the appended claims.

This H.V.A.C. saddle tap is a simple inexpensive effective method of taping a square or rectangular branch line to round or the round sides of flat oval main trunk lines of many different sizes. The use of this fitting gives a smooth, less turbulent air flow saving energy. The tap size at the main line is much larger than at the discharge to the branch line for a large volume of air. It has an interior air extractor for more air if needed in long or restricted branch lines. The extractor flexibly adapts to the main line or short section of pipe or fitting it is attached to. Also attached to the extractor is multi position depth adjustable and securing strap. Pg. 2/12 FIG. 2 and FIG. 3 in extractor 34 there are two holes in the extractor blade 35 and 35A that align with holes 33 and 33A respectfully in the saddle tap fitting. The extractor has a restraining and depth indicator strap 32 which is attached to the upper edge of the extractor. The strap has 3 holes in it. Number 36, 37, 38. The extractor strap hangs down below the extractor blade when the extractor is installed inside the fitting and is riveted thru holes 33 in the tap 35 in the extractor and 33A (not shown) in the tap and 35A in the extractor. This attaches the extractor to the fitting, but still allows it to pivot on these points. Then the strap is bent out so desired hole depth hole 36, 37, or 38 are under tab 30A on the skirt. This aligns with hole 31A in the tab with desired depth hole 36, 37, or 38 in the strap. This serves two purposes, when the attachment screw penetrates hole 31A and desired depth hole 36, 37, or 38 in the strap. This secures the saddle tap and the extractor strap when attached to the main line. There by leaving some of the extractor strap exposed between the attachment tab 30a and the main line. The exposed length of the strap is a use indicator to the air balance technician. This makes it a multi position depth indicator.

### CONCLUSIONS AND RAMIFICATIONS AND SCOPE OF INVENTION

The saddle tap fitting is very useful and serves many situations with its unique flexible shape by having the ability to tightly tap into new or existing HVAC main trunk lines of round or arcuate sides of flat oval pipe and there associated fittings of many different sizes that make up trunk lines. After a air access hole is cut in the main trunk line, and a saddle tap fitting is mounted over the hole and secured it will extract a large volume of regulated conditioned air and efficiently direct it to a rectangular branch line duct or registers or grille. This saddle tap can be used on duct work that is supply return or exhaust. This saddle tap can be used in residential commercial or industrial applications as well as exposed situations. With the use of this saddle tap fittings of many sizes can be eliminated or greatly reduced. The tight fitting saddle tap requires very little duct sealer and appears to be specifically built for the main line that it is attached to. With respect, this saddle tap fitting is obvious it will fit a round pipe but it is unobvious it will fit a large amount of them and associated fittings. This saddle tap fitting has several features such as the attachment tabs. They have dual purpose holes in them which not only help secure the skirt they are necessary to restrain the sharp screws needed when the large air access hole in the main line is cut in. The saddle tap, at attachment time is mounted over the large air hole. Then the sharp screws then penetrate the tab holes and are tipped out at a slight angle away from the large hole in the main line. When the screws penetrate the main line this action stresses the saddle taps skirt with its rounded corners to flexibly to adapt to the main trunk line securely. Another feature is its concealed multi depth air extractor and use indicator strap. See FIG. 2 and FIG. 3 at the time of the saddle tap installation attachment the extractor 34 can be manually pulled down below the skirt of the saddle tap fitting. Then its extractor strap 32 can be bent out under tab 30a on the saddle tap, at the desired usage depth the hole in the strap 32. (Example) hole 36 in extractor strap will line up with hole 31a in the tab 30a. Then when the saddle taps attachment tab hole 31a aligns with 36 in the strap the attachment screw can penetrate hole 31a and hole 36 in the strap and securely anchor in to the main line. This action exposes the strap between 30a and the main line it is attached to, which indicates the extractor depth usage and its dual purpose as extractor securing strap. This information will be beneficial to the air balance technician. Because of this saddle taps many features it will be a great asset to the HVAC industry in general. From manufacturing companies who build it the use of this saddle tap fitting will save the manufacturers the fabrication of complicated specific size fittings and the storage and inventory as well as the shipping of them. The capability for manufacturing one fitting for many sizes of applications and nesting capabilities and for storage will be a great asset to manufacturers. The distributor can take advantage of the capabilities as well plus the availability problems will be greatly reduced. The H.V.A.C. Company can have the same advantage they will not have to stock a wide variety of fittings or hunt for them. These features will save the manufacturer and distributor and the H.V.A.C. Company that installs them time and money. The use of this saddle tap fitting will create jobs save resources use less energy and help the environment.

In conclusion I have multiple sizes and working models of these prototype saddle tap fittings, version one, and version two.

What is claimed is:

1. A saddle tap fitting for heating ventilating and air conditioning known as H.V.A.C duct comprising
1) A fitting for attaching an end of a hollow duct section of a relatively small rectangular cross section to a hollow arcuate surface of a moderately larger or much larger main trunk line cross section.
2) A body having a hollow generally rectangular first end to a generally oval flexible and larger opposite second end. Said end has a serpentine concave and convex arcuate edge at its end
3) A body having a flange bent in at an angle around its upper rectangular perimeter on its first end and. Also skirt flaring outward and downward a distance from said bodies rectangular upper end said skirt terminating in a base on second end. The said skirt having generally opposed first and second longitudinal and horizontal flanges with holes. The said flanges terminating respectively in to serpentine concave and convex arc's on opposite ends, have a plurality of securing attachment tabs with screw restraining holes in said tabs. The said base arc's at its end is disposed between said tabs and contiguous said flanges. At the center of forward and rearward arc's are additional intrical attachment tabs one on each said arc respectively. The saddle tap having an interior pivotal extractor with securing and use indicating adjustment strap and associated multi position securing holes.
4) The saddle tap fitting of claim 1, where in the rectangular first end of said fitting is larger than the perimeter of the register flange.
5) The saddle tap fitting of claim 1, where in said rectangular said first end has a flange bent in at an angle around said perimeter
6) The saddle tap fitting of claim 1, where in said fittings said flange provides a flat surface for registers flange gasket. To seal to as well as said surface for said register screws to tightly attach register to saddle tap.
7) The saddle tap fitting of claim 2, where in said rectangular first end is a ridged rectangular non flexible end.
8) The saddle tap fitting of claim 2, where in said rectangular first end at said register flange corners are at a 90° angle around said registers said perimeter.
9) The saddle tap fitting of claim 2, where in said flange corners said bodies tapering rounded corners continue down to said second larger end.
10) The saddle tap fitting of claim 2, where in second end has rounded corners give the said fitting the ability to be very flexible as said first end is stationary.
11) The saddle tap fitting of claim 3, where in has a said first and second longitudinal and horizontal flanges at the termination of said round corners which are kinked out to form and stiffen the base of said fitting.
12) The saddle tap fitting of claim 3, where in has a plurality of said tabs bent out at an angle from the base end.
13) The saddle tap fitting of claim 3, where in said tabs are rounded for safety purposes to minimize cuts when handling.
14) The saddle tap fitting of claim 3, where in said attachment tabs have pre cut holes.
15) The saddle tap fitting of claim 3, where in said tabs said holes are essential and used to restrain the sharp attachment screws when said screws are tipped at an angle to gain a stressing and compressing effect when attaching said saddle tap to the main line.
16) The saddle tap fitting of claim 3, where in said rounded second generally serpentine edge end is flexible and distorts when said attachment screws penetrates said tabs and said holes into said main trunk line which secures the saddle tap.
17) The saddle tap fitting of claim 3, where in saddle tap fitting has an interior moveable multi depth air extractor with use indicator and securing strap FIG. 3 and FIG. 4.
18) The saddle tap fitting of claim 3, where in a second version is expandable to accommodate various length size registers or duct see FIG. 11 and FIG. 11a and FIG. 11b and FIG. 11c.
19) The saddle tap fitting of claim 3, where in the second version saddle tap fitting see FIG. 11 and FIG. 11a are two separate pieces are easy to make because they are identical, except for two extractor securing holes in one of them. The said two pieces securely interlock and are easily manually expanded or contracted to several different lengths to accommodate said several different lengths of said registers grilles or duct.
20) The saddle tap fitting of claim 3, second version where in FIGS. 11 and 11a has a plurality of inch measuring numbers marks on said register flange to indicate some of the different lengths said fitting can be adjusted to after it is interlocked. This method will indicate various register lengths before installation, saving time and labor.
